(19) United States
(12) Patent Application Publication
(10) Pub. No.: US 2007/0188070 A1
(43) Pub. Date: Aug. 16, 2007

(54) Lighting equipment

(75) Inventor: Piero Gandini, Bovezzo (BS) (IT)

Correspondence Address: MCGLEW & TUTTLE, PC, P.O. BOX 9227, SCARBOROUGH STATION, SCARBOROUGH, NY, 10510-9227, US

(73) Assignee: FLOS SPA, Bovezzo (BS) (IT)

(21) Appl. No.: 10/599,168

(22) PCT Filed: Apr. 5, 2005
(86) PCT No.: PCT/IT05/00186

§ 371 Date: Sep. 21, 2006

(30) Foreign Application Priority Data
Apr. 14, 2004 (IT) MI 2004 A 000734

(51) Int. Cl. H01J 5/00

(52) U.S. Cl. 313/317

(57) ABSTRACT

A lamp is disclosed which comprises a first element and second element placed in line and having, at one of their ends, a first flat base and respectively a second flat base on an inclined plane with respect to the corresponding longitudinal axis, and a first and respectively a second straight sections having the same external perimeter. The first and second flat bases rest on a common contact plane, have the same external perimeter and turn on a common axis of rotation passing through their centre at right angles to the contact plane.

### FIELD OF THE INVENTION

This invention concerns a lamp for illumination preferably but not exclusively for internal use.

### PRIOR ART

As is known, traditional lamps are made up of parts connected together and operating in order to position and point the light source.

These lamps have the drawback that, although being extremely flexible as regards to possibility of use, they can sometimes be bulky, difficult to manoeuvre, not firmly fixed in the various operating positions, or firmly fixed in the operating positions but at the cost of having to use very complicated structures and/or penalising the aesthetics and/or increasing costs.

### OBJECTS OF THE INVENTION

The technical task this invention puts forward is, therefore, to provide a lamp that removes the technical drawbacks complained about in the known technique. Within the sphere of this technical task, one objective of the invention is to realize a lamp having flexibility of use enabling positioning and pointing of the light source.

Another object of the invention is to provide a lamp which, by means of a simple manoeuvre, enables positioning and pointing of light source in different operating positions.

Yet another object of this invention is to provide a lamp which blocks firmly in the different operating positions.

An additional object of this invention is to provide an ergonomic, compact lamp, structurally simple and inexpensive and easy to assemble.

Not the least object of this invention is to produce a valuable, aesthetic lamp able to fully house the structural elements that form the operating connection between the parts.

The technical task as well as these and other objects are achieved, according to this invention, by a lamp characterised by the fact that it comprises a first element and respectively a second element with longitudinal elongation placed in line with one of their ends, a first flat base and respectively a second flat base on an inclined plane compared with the corresponding longitudinal axis, and a first and respectively a second straight section having the same external perimeter, said first and second flat bases resting on a common contact plane, having the same external perimeter and turning on a common axis of rotation passing through their centre at right angles to said contact plane.

This invention also discloses an assembly process of a lamp made up of a first and second elements with longitudinal elongation turning on a common axis of rotation passing at right angles through the centre of a contact plane along which a first flat base of said longitudinal element is associated and a second flat base of said second longitudinal element, characterised by the fact to provide a rotating group having a first and second rotating elements relatively turning on said axis of rotation and constrained in respect to the translation along said axis of rotation, to apply said rotating group to said first longitudinal element, fixing said first rotating element to a first support plate secured to said first longitudinal element, to secure a second plate to said second longitudinal element, to fit said second plate into to said second rotating element using mechanical pressure, to turn said first longitudinal element in respect to said second longitudinal element so as to offset said first base in respect to said second base so as to uncover the locations of engaging screws between said second rotating element and said second plate, and to screw said engaging elements into relative locations.

Furthermore, other features of this invention are defined in the following claims.

### BRIEF DESCRIPTION OF THE DRAWINGS

Further features and advantages of the invention will become more evident from the description of a preferable but not exclusive embodiment of the lamp according to the invention, illustrated in the indicative and not limitative enclosed drawings, in which:

FIGS. 1a, 1b and 1c show a view of a lamp in compliance with this invention in three different operating positions, in particular in a first operating position in which the two elements with longitudinal elongation have aligned axes, in a second operating position reached by a 90° rotation in respect to the first operating position, and in a third operating position reached by a 180° rotation in respect to the first operating position;

FIG. 2 shows a view of the lamp in FIGS. 1a, 1b and 1c cross-sectioned along the axes of the longitudinal elongation elements that form it; and

FIGS. 3 and 4 show two different perspectives of some exploded components of the rotating group of the lamp in FIGS. 1a, 1b and 1c.

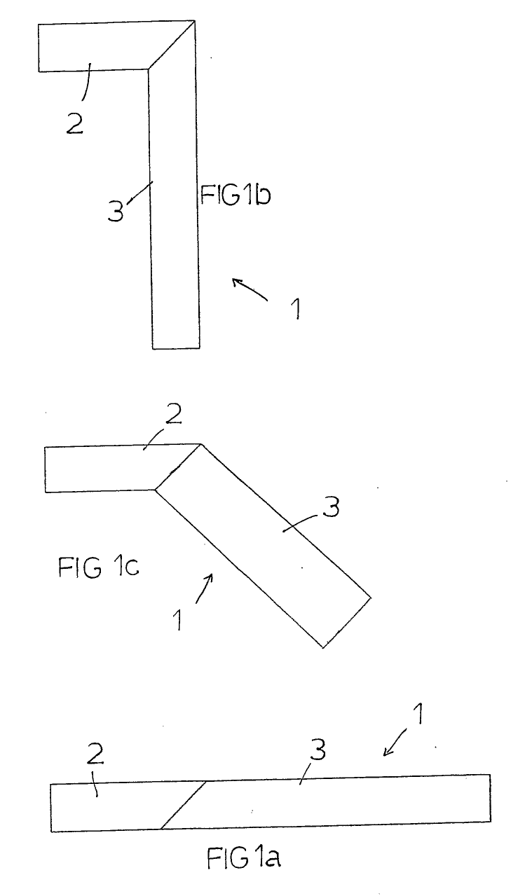

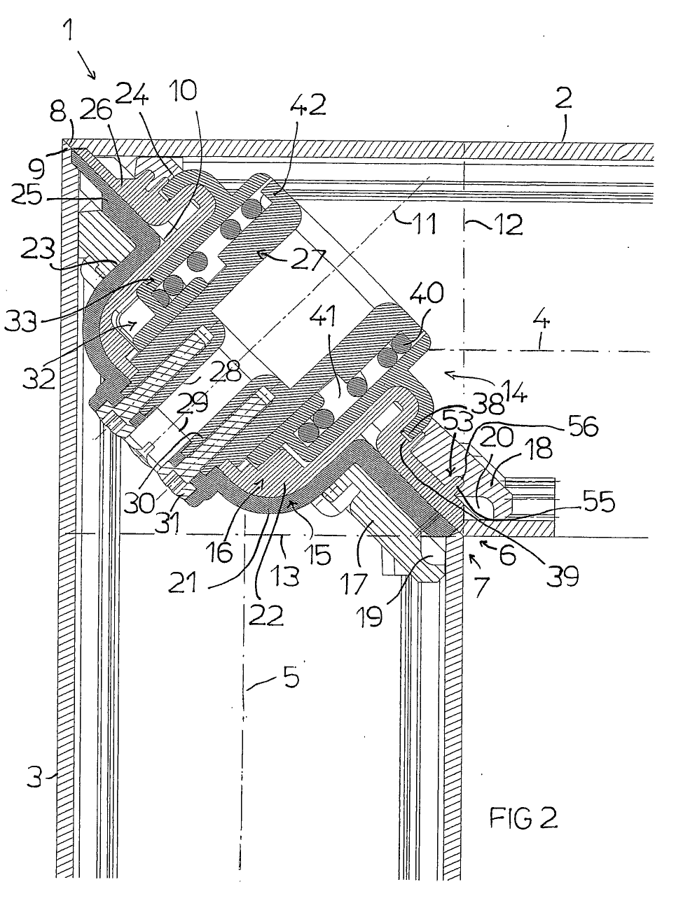

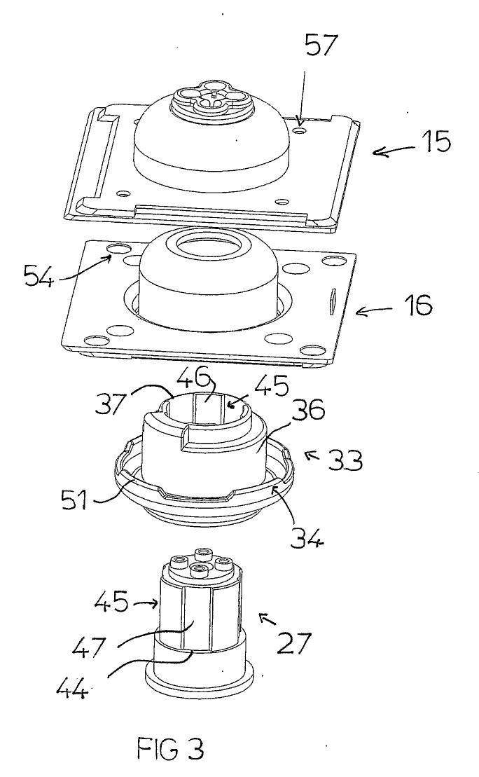

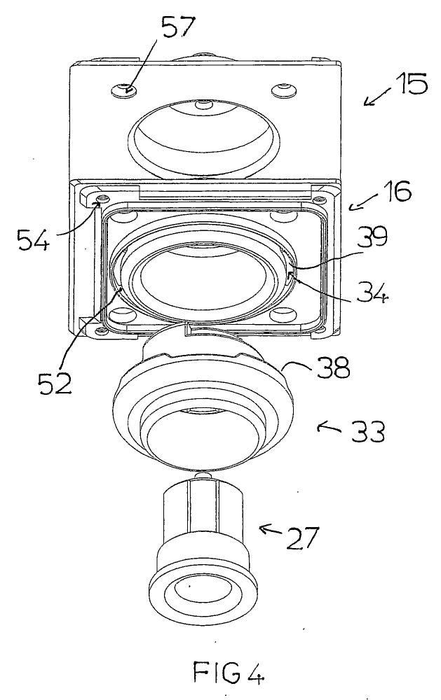

### DETAILED DESCRIPTION OF THE INVENTION

With reference to the cited figures, a lamp is indicated reference number 1 on the whole. Lamp 1 is made up of a first and second element s respectively 3 and 4 which develop along a respective longitudinal axis 5 and 4 and have, in correspondence with one of their respective ends 7 and 6, a first and respectively a second flat plane 9 and 8 sloping in respect to the corresponding longitudinal axis 5 and 4.

In preference, the longitudinal elements 2 and 3 are made of metal profiles with hollow internal section.

One of the elements, either 2 or 3 is fixed and forms the support of the lamp 1 whereas the other can be positioned and holds at least one lighting element (not shown).

The lighting element of course can be housed in a location accessible through an aperture.

The first and second flat planes 9 and 8 lie along a common contact plane 10, and have an identical external perimeter.

The first and second flat planes 9 and 8 can furthermore turn around a common axis of rotation 11 passing through their centre at right angles to the contact plane 10.

The first and second longitudinal elements 3 and 2, respectively, have at least one first and second straight sections, respectively 13 and 12, with an identical external perimeter, in particular at least their straight section positioned in correspondence with their facing ends.

The first and second longitudinal elements 3 and 2 shown here have, as an example, a straight rectangular section and flat bases 9 and 8 with square perimeters inclined at 45° with respect to the longitudinal axes 5 and 4 so as to allow bases 9 and 8 to fit together perfectly for successive 90° turns between the first and second longitudinal element 3 and 2; obviously different shapes are equally possible.

For example, the first and second longitudinal elements 3 and 2 could have an elliptical straight section and flat bases 9 and 8 with a circular perimeter.

Lamp 1 comprises a rotating group 14 having at least a first and second rotating elements 15 and 16 relatively turning on the axis of rotation 11 and secured together with respect to the translation along the axis of rotation 11.

Lamp 1 also comprises means of support for the rotating group 14 made up of a first support plate 17 for the first rotating element 15 and secured to the first longitudinal element 3 and a second plate 18 secured to the second longitudinal element 2 and engaging with the second rotating element 16.

Although in the drawings, for the sake of example, there is a joining between the first support plate 17 and the first longitudinal element 3 achieved by a first welding bead carried out along a first under bevel 19 of perimetrical welding of the first plate 17, and a joining between the second support plate 18 and the second longitudinal element 2 by means of a second welding bead carried out along a second perimetric welding bevel 20 of the second plate 18, it is equally possible to join the said parts simply using anchoring screws (not shown).

The first and second plates, respectively 17 and 18, are positioned inside the longitudinal element section 3 and 2 whose bases 9 and 8 are respectively associated and in particular parallel and very close to each other.

The first plate 17 supports the rotating group 14 locating it through the contact plane 10 partly inside the section of the first longitudinal element 3 and partly inside the section of the second longitudinal element 2.

The first and second rotating elements, respectively 15 and 16, comprise a first and a second cap, respectively 21 and 22, fitting coaxially one inside the other with axis coincident with the axis of rotation 11.

The first and second caps, respectively 21 and 22, are placed through openings 23 and 24 facing the first and second plates 17 and 18, and extend externally and perimetrically in a first and second flanges, respectively 25 and 26, held between the first and second plate 17 and 18 and in reciprocal contact along the contact plane 10.

The rotating group 14 furthermore comprises an axial stop element 27 of the second rotating element 16, located inside the second rotating element 16 and rigidly fixed to the first rotating element 15 by means of the wall thickness of the second rotating element 16.

In particular the stop or check device 27 has a sleeve 28 in which a supporting and centring hub 29 is inserted which extends axially and internally to the first rotating element 15.

In the outside wall of sleeve 28, special allocations 30 are provided for receiving connecting screws 31 with the first rotating element 15.

The rotating group 14 also comprises blocking devices 32 engaging at intervals in the relative rotation between the first and second rotating element 15 and 16.

The blocking devices 32 comprise an insert 33 rotating in conjunction with the first rotating element 15 and sliding along the rotation axis 11, and first engaging means 34 between the insert 33 and the second rotating element 16, which can be engaged at each step of the rotation.

The insert 33 comprises a third cap fitting into the second rotating element 16 and made up of a lateral wall 36 and a ring shaped base 37 through which the check device 27 is positioned.

The insert 33 slides between the internal lateral wall of the second rotating element 16 and the external lateral wall of the check element 27.

The first engaging means 34 comprise a first group of engaging members 38 and a second group of engaging members 39 kept in contact, in contrast and operating by a elastic element 40.

The elastic element 40 comprises a helicoid spring housed under compression and with its axis coincident with the axis of rotation 11 in an annular seat 41 formed between the insert 33 and the check device 27.

The annular seat 41 is closed at its axial ends by the annular base 37 of insert 33 and by a third top perimetrical flange 42 of the check device 27 projecting towards the lateral wall 36 of the insert 33.

The rotating group 14 furthermore comprises second engaging means 45 between the insert 33 and the check device 27 so as to selectively block the relative rotation but not the relative axial translation between the insert 33 and the check device 27.

These second engaging means 45 comprise a number of projections 46, or respectively, impressions, formed along the internal perimeter of the annular base of the insert 33 and sliding in a number of corresponding impressions 47, or respectively corresponding projections, formed perimetrically to the lateral wall of the check device 27.

The impressions 47 have shoulders 44 for engaging the projections 46 so as to establish the end of stroke of insert 33.

The first and respectively the second number of engaging members 38 and 39 are formed by a shaping of the profile of a fourth flange 49 extending perimetrically and externally to the lateral wall 36 of insert 33 and respectively by a counter shaping of the second flange 25.

In particular the shaping envisages protrusions 51 which engage with the corresponding indents 52 in the counter shaping or vice versa.

Lamp 1 has third mechanical engaging members 53 and fourth screw engaging members 54 between the second flange 26 of the second rotating element 16 and the second plate 18.

In particular the third engaging members 53 comprise at least one press-fit means 55, fitting into at least one corresponding receptacle 56.

Lamp 1 also comprises fifth screw engaging members 57 between the first flange 25 of the first rotating element 15 and the first plate 17.

This invention also includes the assembly process of light 1 including the steps of: fitting the rotating group 14 to the first longitudinal element 3 by fixing the first rotating element 15 to the first support plate 17 which, in turn, is fixed to the first longitudinal element 3; fitting the second plate 18 to the second longitudinal element 2; associating by a mechanical pressure fitting, the second plate 18 to the second rotating element 16; rotating the first longitudinal element 3 in respect to the second longitudinal element 2 until the first base 9 is out of phase in respect to the second base 8 so as to uncover the locations for the screw engaging means of the fourth engaging members 54 between the second rotating element 16 and the second plate 18; and finally screwing these engaging members into the relative receiving locations.

In order to assemble the rotating group 14, at first the second rotating element 16 in fitted in the first rotating element 15, then the insert 33 together with the flexible element 40 in fitted in the second rotating element 16, and finally the check device 27 is fitted in the insert 33 and secured to the first rotating element 15.

The lamp thus conceived is susceptible to numerous changes and variations, all falling within the scope of the invention concept; furthermore all the details can be replaced by technically equivalent elements.

In practice, the materials used, including the dimensions, may differ according to the needs and the technical requirements.

1. A lamp characterized by the fact that it comprises a first and respectively second elements with longitudinal elongation placed in line, having at one of their ends, a first flat base and respectively a second flat base on an inclined plane with respect to the corresponding longitudinal axis, and a first and respectively a second straight sections having the same external perimeter, and wherein said first and second flat bases rest on a common contact plane, have the same external perimeter and turn on a common axis of rotation passing through their center at right angles to said contact plane.

2. A lamp according to claim 1, characterized in that said first base and second base have a circular perimeter.

3. A lamp according to claim 1, characterized in that said first base and second base have a square perimeter.

4. A lamp according to claim 1, characterized in that said first and second straight sections respectively are in correspondence with said end of said first element and, respectively, second element with longitudinal elongation.

5. A lamp according to claim 1, characterized in that it comprises a rotating group having at least one first and, respectively, second rotating elements turning on said axis of rotation and constrained in respect to the translation along said axis of rotation, and means of support for said rotating group comprising a first support plate of said first rotating element associated with said first longitudinal element, and a second plate associated with said second longitudinal element and engaged with said second rotating element.

6. A lamp according to claim 1, characterized in that said first support plate holds said rotating group positioning it through said contact plane.

7. A lamp according to claim 1, characterized in that said first and second rotating elements respectively comprise a first and a second coaxial cap fitting one into the other with axis coincident with said axis of rotation.

8. A lamp according to claim 1, characterized in that said first and second cap respectively extend externally and perimetrically in a first and second flange respectively in reciprocal contact along said contact plane.

9. A lamp according to claim 1, characterized in that said rotating group comprises furthermore an axial stop element of the second rotating element, located inside said second rotating element and rigidly fixed to the first rotating element through the wall thickness of the second rotating element.

10. A lamp according to claim 1, characterized in that said rotating group comprises furthermore blocking means to arrest the relative rotation step by step between said first and second rotating elements.

11. A lamp according to claim 1, characterized in that said blocking means comprise an insert rotating together with said first rotating element and sliding along said axis of rotation, and first engaging members between said insert and said second rotating element which can become engaged at each step of said rotation.

12. A lamp according to claim 1, characterized in that said first engaging members comprise a first group of engaging devices and a second group of engaging devices kept in contact, in contrast and through the action of a elastic element.

13. A lamp according to claim 1, characterized in that said insert comprises a third cap fitting into said second rotating element.

14. A lamp according to claim 1, characterized in that said third cap comprises a lateral wall and an annular base through which a check device is positioned.

15. A lamp according to claim 1, characterized in that said insert slides guided between the internal lateral wall of said second rotating element and the external lateral wall of said check device.

16. A lamp according to claim 1, characterized in that said elastic element comprises a helicoid spring.

17. A lamp according to claim 1, characterized in that said insert forms with said check device an annular housing in which said helicoid spring is located and compressed, with axis placed along said axis of rotation.

18. A lamp according to claim 1, characterized in that said annular housing is closed at its axial ends by said annular base of said insert and by a third top, perimetral flange of said check device, projecting towards the lateral wall of the insert.

19. A lamp according to claim 1, characterized in that said rotating group furthermore comprises second engaging means between the insert and the check device so as to selectively block the relative rotation but not the relative axial translation between the insert and the check device.

20. A lamp according to claim 1, characterized in that said engaging means comprise a number of projections, or respectively, impressions, formed along the internal perimeter of the annular base of the sliding insert in a number of corresponding impressions, or respectively corresponding projections, formed perimetrically to the lateral wall of said check device.

21. A lamp according to claim 1, characterized in that said first and respectively second number of engaging means are formed by a shaping of the profile of a fourth flange extending perimetrally and externally to the lateral wall of insert and respectively by a counter shaping of the second flange

22. A lamp according to claim 1, characterized in that it has a third mechanical engaging means and fourth screw engaging members between the second flange of the second rotating element and the second plate.

23. A lamp according to claim 1, characterized in that said third engaging devices comprise at least one press-fit device, fitting into at least one corresponding receptacle.

24. A lamp according to claim 1, characterized in that said fifth screw engaging members are located between the first flange of the first rotating element and the first plate.

25. A lamp according to claim 1, characterized in that said first longitudinal element holds and is associated with at least one lighting element and said second longitudinal element forms a support for said lamp or vice versa.

26. An assembly process of a lamp comprising a first and second elements with longitudinal elongation rotating on a common axis of rotation passing at right angles through the center of a contact plane along which a first flat base of said longitudinal element is associated and a second flat base of said second longitudinal element, characterized by the fact that of providing a rotating group having a first and second rotating element relatively turning on said axis of rotation and secured in respect to the translation along said axis of rotation; applying said rotating group to said first longitudinal element; fixing said first rotating element to a first support plate secured to said first longitudinal element; applying a second plate to said second longitudinal element, fitting said second plate into said second rotating element by mechanical pressure, turning said first longitudinal element in respect to said second longitudinal element so as to offset said first base in respect to said second base in order to uncover the locations of engaging screws between said second rotating element and said second plate, and screwing said engaging elements into relative locations.
